(19) United States
(12) Patent Application Publication
(10) Pub. No.: US 2026/0200517 A1
(43) Pub. Date: Jul. 16, 2026

(54) Child Stroller Frame

(71) Applicant: Zhongshan Youyoubei Daily Products Co. Ltd., Zhongshan City (CN)

(72) Inventor: Yijin Mo, Zhongshan City (CN)

(21) Appl. No.: 19/386,233

(22) Filed: Nov. 12, 2025

(30) Foreign Application Priority Data
Jan. 15, 2025 (CN) 202520096837.4

(51) Int. Cl. B62B 7/06; B62B 7/08; B62B 7/14; B62B 9/10

(52) U.S. Cl. CPC B62B 7/062; B62B 7/064; B62B 7/083; B62B 7/14; B62B 9/104; B62B 2205/18; B62B 2205/24

(57) ABSTRACT

A child stroller frame includes a push rod assembly, a front support rod, a rear support rod, a connecting seat, a first connecting portion on the front support rod, a second connecting portion on the push rod assembly, the first connecting portion and the connecting seat are pivotally connected around a first axis, the second connecting portion and the connecting seat are pivotally connected around a second axis, a first end of a linkage rod is connected to the first connecting portion around a third axis, and a second end thereof is connected to the second connecting portion around a fourth axis. The two connecting portions are both provided with locking positions, and the connecting seat is provided with a locking member that can slide with respect to connecting seat and lock or disengage with each locking position simultaneously.

### CROSS REFERENCE OF RELATED APPLICATION

This application is a non-provisional application that claims priority under 35U.S.C. §119 to China application number CN202520096837.4, filing date 01/15/2025, wherein the entire content of which is expressly incorporated herein by reference.

### BACKGROUND OF THE PRESENT INVENTION

### FIELD OF INVENTION

The present invention relates to a child stroller frame.

### DESCRIPTION OF RELATED ARTS

Strollers are common products for infants and young children to grow up in. Current strollers can generally be unfolded or folded, and can be used for children to travel in the unfolded state, and can be stored or carried in the folded state.

The Chinese utility model patent CN221188720U is a prior patent applied by the inventor in 2023. The patent discloses a child stroller, the main technical scheme of which is that when the seat is rotated and folded with respect to the mounting base, the locking assembly between the front legs, the rear legs and the struts can be driven to unlock, so that the child stroller can be folded conveniently. However, the child stroller structure has the following shortcomings: it is inconvenient to unlock the locking assembly after the seat is removed from the mounting base, because the exposed part of the unlocking piece that cooperates with the seat to unlock is very small, which is not enough to facilitate the finger movement of adults, and in order to avoid interference or unsmoothness during the rotation and unfolding or rotation and folding of the seat, the unlocking piece cannot be made large enough to facilitate the finger movement of adults. Therefore, the scheme cannot meet the convenience of folding the front legs, the rear legs and the struts separately after the seat is disassembled. In fact, for infants and young children, they are placed flat in the sleeping basket when they are just born, and the sleeping basket is installed on the frame when they travel, and adults push them to travel. As infants and young children grow up to a certain age, the sleeping basket is no longer suitable for children to travel. When traveling, you can choose to install the seat on the frame, and the child sits in the seat. However, when the aforementioned prior patent technical solution is connected to the baby sleeping basket on the mounting base, since the baby sleeping basket cannot drive the locking assembly between the front legs, the rear legs and the support rods to unlock, and there is no other unlocking component that can independently operate the locking assembly to unlock, the aforementioned prior patent application technical solution is not suitable for connecting the baby sleeping basket to the frame, resulting in a small scope of application of the product.

### SUMMARY OF THE PRESENT INVENTION

The invention is advantageous in that it provides a child stroller frame which is easy to unlock and fold and has a wide range of applications.

The present invention is realized by the following technical solutions.

A child stroller frame comprises a push rod assembly, a front support rod and a rear support rod, both of the front rod and the rear support rod are connected with wheels, wherein a connecting seat is fixedly provided at an upper end of the rear support rod, a first connecting portion is fixedly provided at an upper end of the front support rod, a second connecting portion is fixedly provided at a lower end of the push rod assembly, a connector which can be detachably connected to the seat assembly is provided on an inner side of the connecting seat, the first connecting portion and the connecting seat are pivotally connected around a first axis, the second connecting portion and the connecting seat are pivotally connected around a second axis, a linkage rod is provided between the first connecting portion and the second connecting portion, wherein the linkage rod is pivotally connected to the first connecting portion and the second connecting portion and can drive the front support rod to rotate toward the rear support rod when the push rod assembly is rotated and folded with respect to the rear support rod, wherein a first end of the linkage rod is connected to the first connecting portion around a third axis, and a second end of the linkage rod is connected to the second connecting portion around a fourth axis. The first connecting portion and the second connecting portion are both provided with locking positions, and the connecting seat is provided with a locking member that can slide with respect to connecting seat and lock or disengage with each locking position at the same time. The locking member is provided with a first unlocking part exposed on the connecting seat and can be pushed by the seat part of the seat assembly when the seat assembly is rotated and folded forward toward the front support rod, so that the locking member is disengaged from the locking positions. A first reset spring that can push the locking member to reset is provided between the locking member and the connecting seat.

The locking member comprises a sliding seat slidably connected to the connecting seat, and the sliding seat is provided with two locking pins which can be respectively locked into the locking positions.

The connecting seat is provided with a sliding groove capable of guiding each locking pin to slide.

A front cross bar is provided at a lower end of the front support rod, a rear cross bar is provided at a lower end of the rear support rod, a rotating rod which can rotate with respect to the front cross bar is provided on the front cross bar, a flexible belt which can pull up the rotating rod when the child stroller frame is in an unfolded state is provided between the rotating rod and the rear cross bar, and a torsion spring which can push the rotating rod to unfold when the stroller frame is folded is also provided between the rotating rod and the front cross bar.

The locking member further comprises a sliding block connected to the sliding seat, the sliding block is partially extended outside the connecting seat, the first unlocking portion is arranged on the sliding block, and the sliding block is provided with a second unlocking portion exposed on the connecting seat and capable of being operated to disengage the locking member from the locking positions.

The seat assembly comprises a mounting base detachably connected to the connector, the seat part is rotatably connected to the mounting base, the seat part is provided with a backrest part and an armrest part, the backrest part can rotate with respect to the seat part, and a locking assembly that can lock the seat assembly in the unfolded state is provided between the mounting base, the seat part, the backrest part and the armrest part.

The seat part comprises a seat plate and an unlocking part which is arranged on the seat plate and can push the first unlocking portion to disengage the locking member from the locking positions when the seat part is rotated with respect to the mounting base. The unlocking part comprises an unlocking slider which is slidably connected to the seat plate and can push the first unlocking portion to slide when the seat part is rotated and folded with respect to the mounting base. A resetting element which can push the unlocking slider to reset is also arranged between the unlocking slider and the seat plate. A first inclined surface is arranged on the unlocking slider. The first unlocking portion is provided with a pushing surface which can push the first inclined surface to retract the unlocking slider into the seat plate when the seat assembly is unfolded.

A locking unit, which is capable of locking the mounting base and the connector, is provided between the mounting base and the connector, the locking unit comprises a lock position provided on the connector, the mounting base is provided with a lock block capable of sliding laterally with respect to the lock block to engage in or disengage from the lock position, an operating member is connected to the mounting base and is capable of sliding vertically with respect to the mounting base to push the lock block to slide laterally, a first elastic element, which is capable of pushing the lock block to reset, is provided between the lock block and the mounting base, and a second elastic element, which is capable of pushing the operating member to reset, is provided between the operating member and the mounting base.

A position adjustment structure capable of adjusting an inclination position of the backrest part with respect to the seat part is provided between the seat part and the backrest part, the position adjustment structure comprises a plurality of adjustment positions provided on the seat part, a sliding member capable of sliding with respect to the backrest part is provided on the backrest part, a snap-in portion capable of being snapped into the adjustment position is provided on the sliding member, an unlocking member capable of rotating relative thereto is provided on the backrest part, a first cable capable of connecting the unlocking member and the sliding member is provided between the unlocking member and the sliding member, and a second reset spring capable of pushing the sliding member to reset is provided between the sliding member and the backrest part.

The seat part is further provided with a stopper that can prevent the sliding member from rotating forward, and a second locking assembly is provided between the unlocking member and the backrest part. The second locking assembly comprises an unlocking button provided on the unlocking member, a protrusion is provided on the unlocking button, and a groove is provided on the backrest part that can make way for the protrusion so that the first cable pulls the sliding member out of the stopper. An elastic part that can push the protrusion on the unlocking button and the backrest part to be misaligned is provided between the unlocking button and the backrest part.

The seat assembly further comprises a leg rest plate rotatably connected to the seat part, an adjustment assembly capable of adjusting an angle of the leg rest plate with respect to the seat part is provided between the leg rest plate and the seat part, the adjustment assembly comprises a left rotating shell provided on the seat part and a right rotating shell provided on the leg rest plate, a slot is provided in each of the left rotating shell and the right rotating shell, the left rotating shell and the right rotating shell form an movement space, a second spline is provided in the movement space which can move laterally therein and can be engaged with the slots of the left rotating shell and the right rotating shell at the same time, and an elastic component is provided between the second spline and the left rotating shell, a rotating member that can rotate with respect to the second spline and the right rotating shell is provided between the second spline and the right rotating shell, and a pusher protrusion that can push the rotating member to slide horizontally when the rotating member is rotated, and when the rotating member slides horizontally, the second spline can be disengaged from the slot on the right rotating shell, and the leg rest plate is further provided with an operating element that can slide with respect to the leg rest plate, a second cable that can drive the rotating member to move when the operating element is operated is provided between the operating element and the rotating member, and an elastic reset member that can push the operating element to reset is provided between the operating element and the leg rest plate.

Compared with the prior art, the present invention has the following advantages.

1. When the stroller frame needs to be folded, the seat part can push the first unlocking portion when the seat part is rotated and folded with respect to the rear support rod, so that the locking member is disengaged from each locking position at the same time. At this time, the front support rod, the rear support rod and the push rod assembly are unlocked from each other, and the user can operates the push rod assembly, at this time, the second connecting portion is rotated with respect to the connecting seat around the second axis to make the push rod assembly move close to the rear support rod. During the rotation of the second connecting portion, the second connecting portion drives one end of the linkage rod to follow the movement, and one end of the linkage rod moves around the fourth axis, and the other end of the linkage rod is pulled to move with respect to the first connecting portion around the third axis. The first connecting portion and the second connecting portion are both provided with the locking positions, and the locking member can be locked with the locking positions on the first connecting portion and the second connecting portion at the same time, so that the whole child stroller frame is safer when unfolded and the shaking of the child stroller frame is reduced.

2. The locking position is a locking groove, and the two locking pins can be simultaneously locked into the locking grooves of the first connecting portion and the second connecting portion, making the entire child stroller frame safer when unfolded.

### BRIEF DESCRIPTION OF THE DRAWINGS

FIG. 1 is a perspective view of a child stroller frame of the present invention with a seat assembly removed;

FIG. 2 is another perspective view of the child stroller frame of the present invention with the seat assembly removed;

FIG. 3 is an enlarged view of the E region in FIG. 2;

FIG. 4 is a schematic view illustrating a connection between a push rod assembly, a front support rod, a rear support rod and a connecting seats of the child stroller frame of the present invention;

FIG. 5 is another schematic view illustrating the connection between a push rod assembly, a front support rod, a rear support rod and a connecting seats of the child stroller frame of the present invention;

FIG. 6 is an exploded view illustrating the connecting seat, the front support rod, the rear support rod, the push rod assembly, a linkage rod and a locking mechanism of the child stroller frame of the present invention;

FIG. 7 is another exploded view illustrating the connecting seat, the front support rod, the rear support rod, the push rod assembly, the linkage rod and the locking mechanism of the child stroller frame of the present invention;

FIG. 8 is a side view of the child stroller frame of the present invention in an unfolded state;

FIG. 9 is a side view of the child stroller frame of the present invention during folding;

FIG. 10 is a perspective view of the child stroller frame of the present invention when being configured with a seat assembly;

FIG. 11 is a perspective view illustrating the seat assembly of the present invention;

FIG. 12 is an exploded view of the seat assembly of the present invention;

FIG. 13 is another exploded view of the seat assembly of the present invention;

FIG. 14 is another perspective view of the seat assembly of the present invention;

FIG. 15 is a perspective view illustrating a spline structure of the present invention;

FIG. 16 is a perspective view illustrating a backrest part of the present invention;

FIG. 17 is a perspective view illustrating a second locking assembly of the present invention;

FIG. 18 is an exploded view illustrating a seat part and a leg rest plate of the present invention;

FIG. 19 is another exploded view illustrating the seat part and the leg rest plate of the present invention;

FIG. 20 is a perspective view of the child stroller frame of the present invention when being configured with a baby sleeping basket;

FIG. 21 is a perspective view of the child stroller frame of the present invention in a folded state.

### DETAILED DESCRIPTION OF THE PREFERRED EMBODIMENT

The present invention is further described below in conjunction with the accompanying drawings:

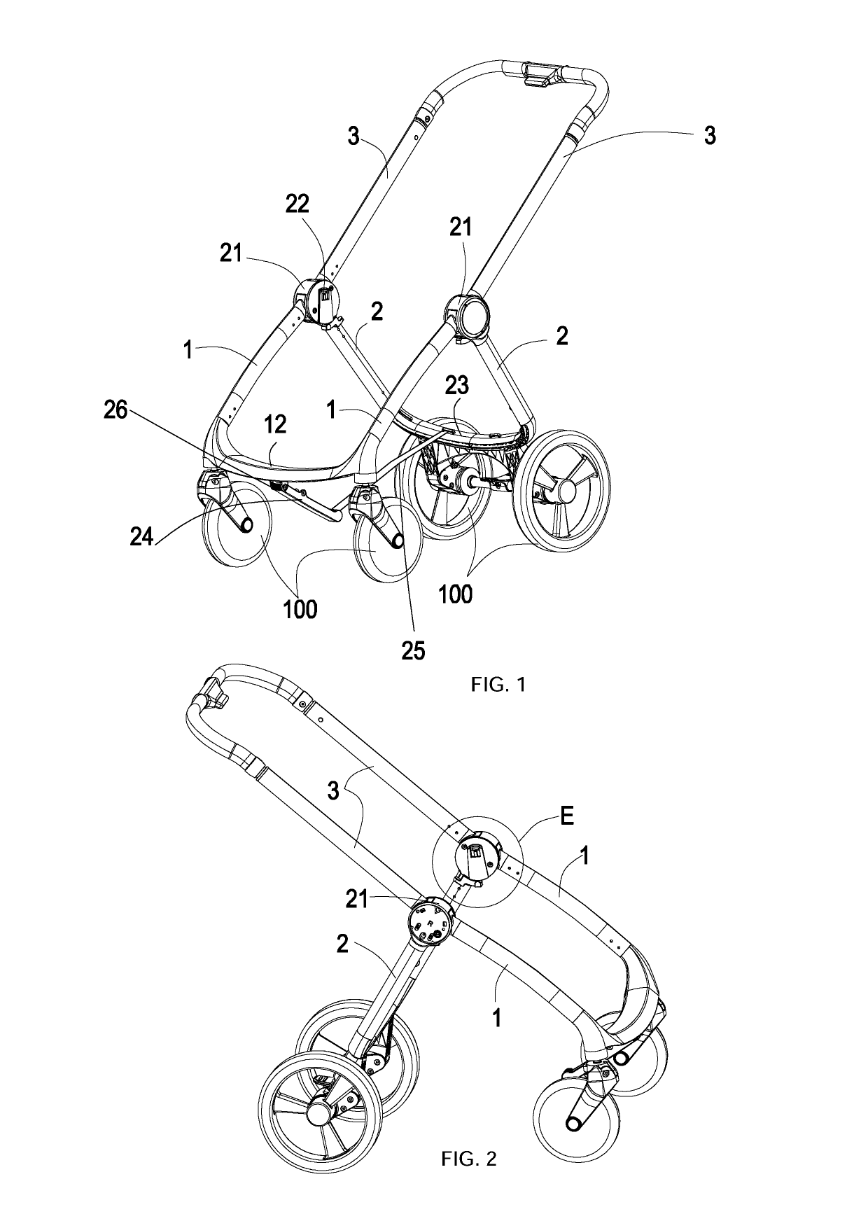

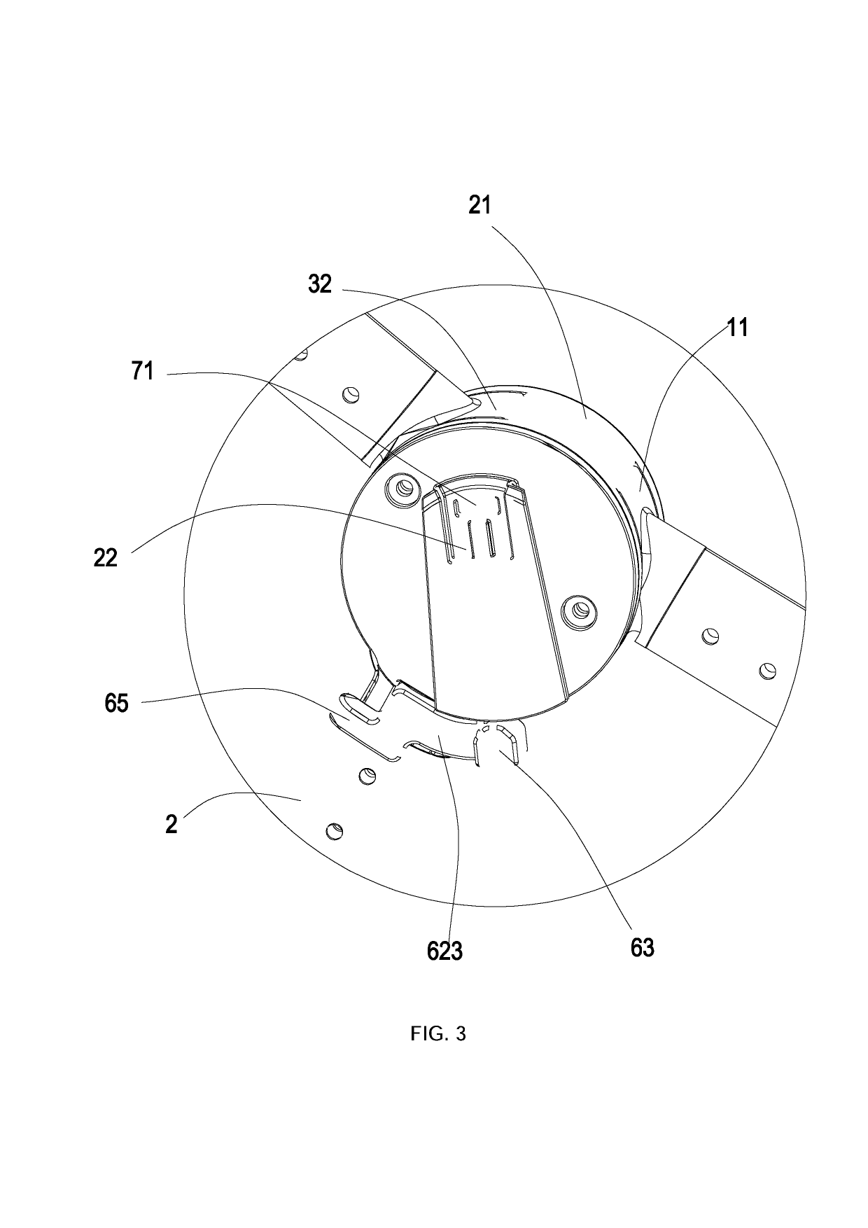

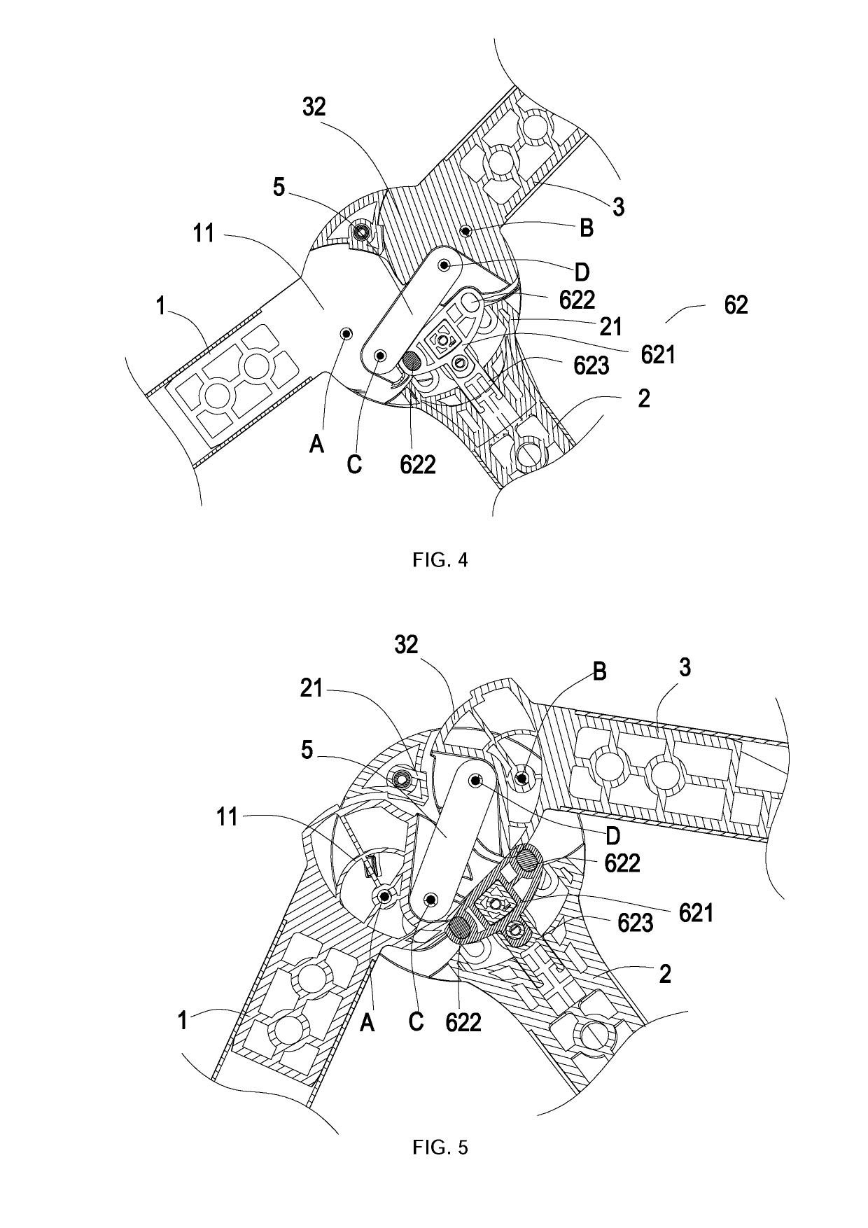

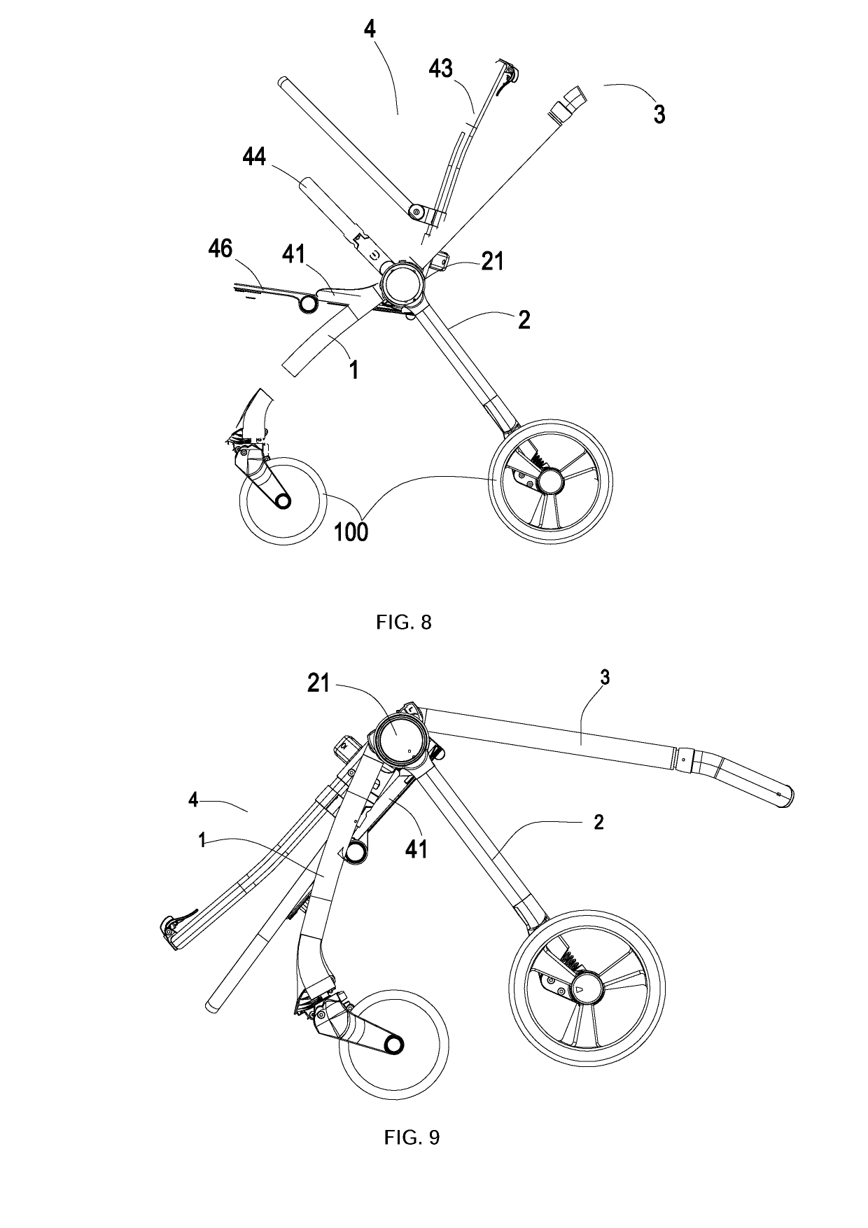

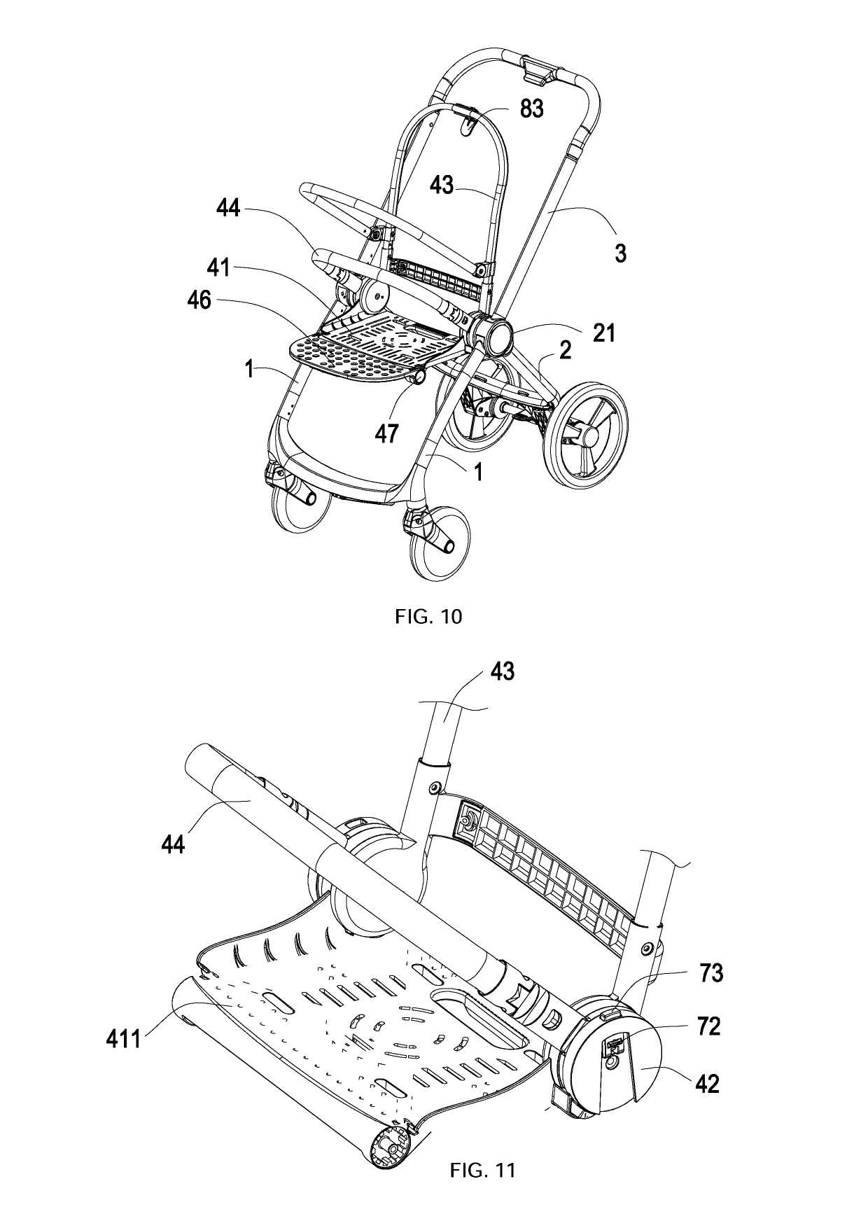

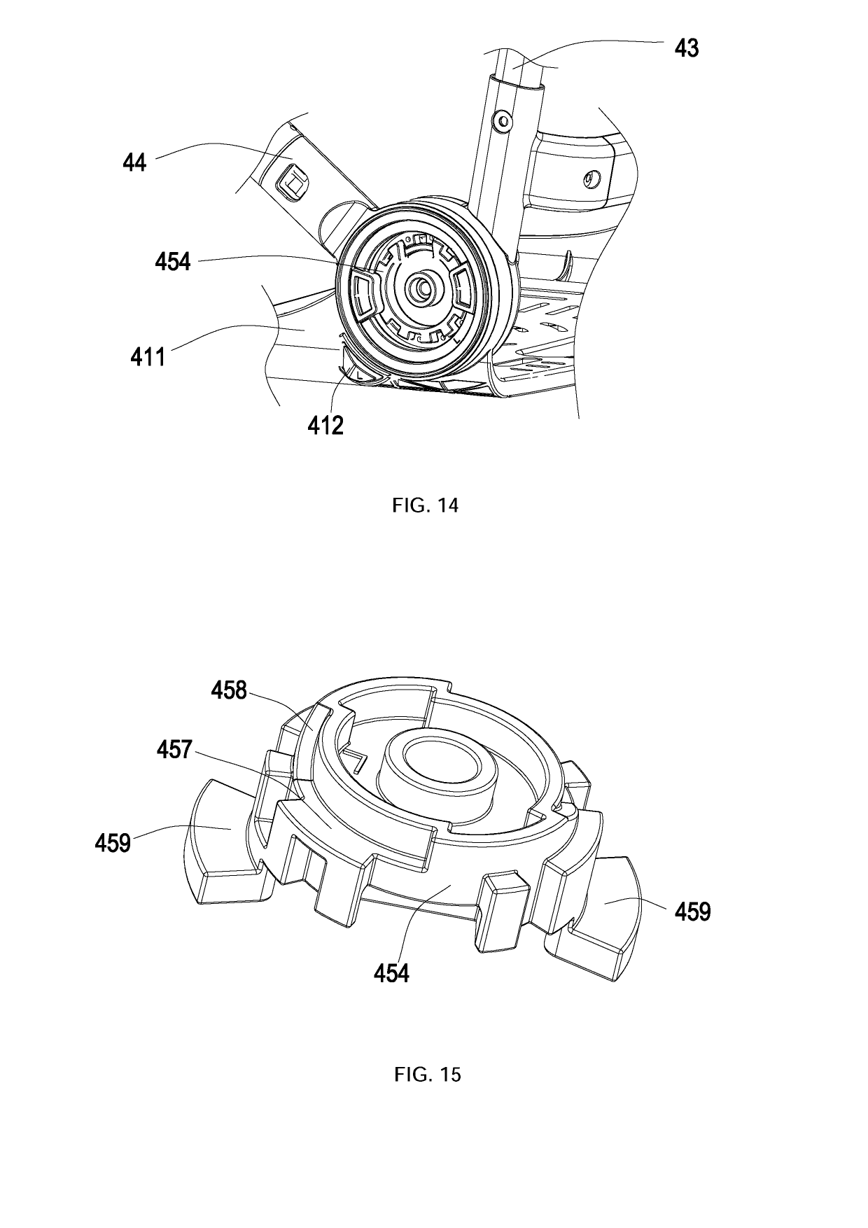

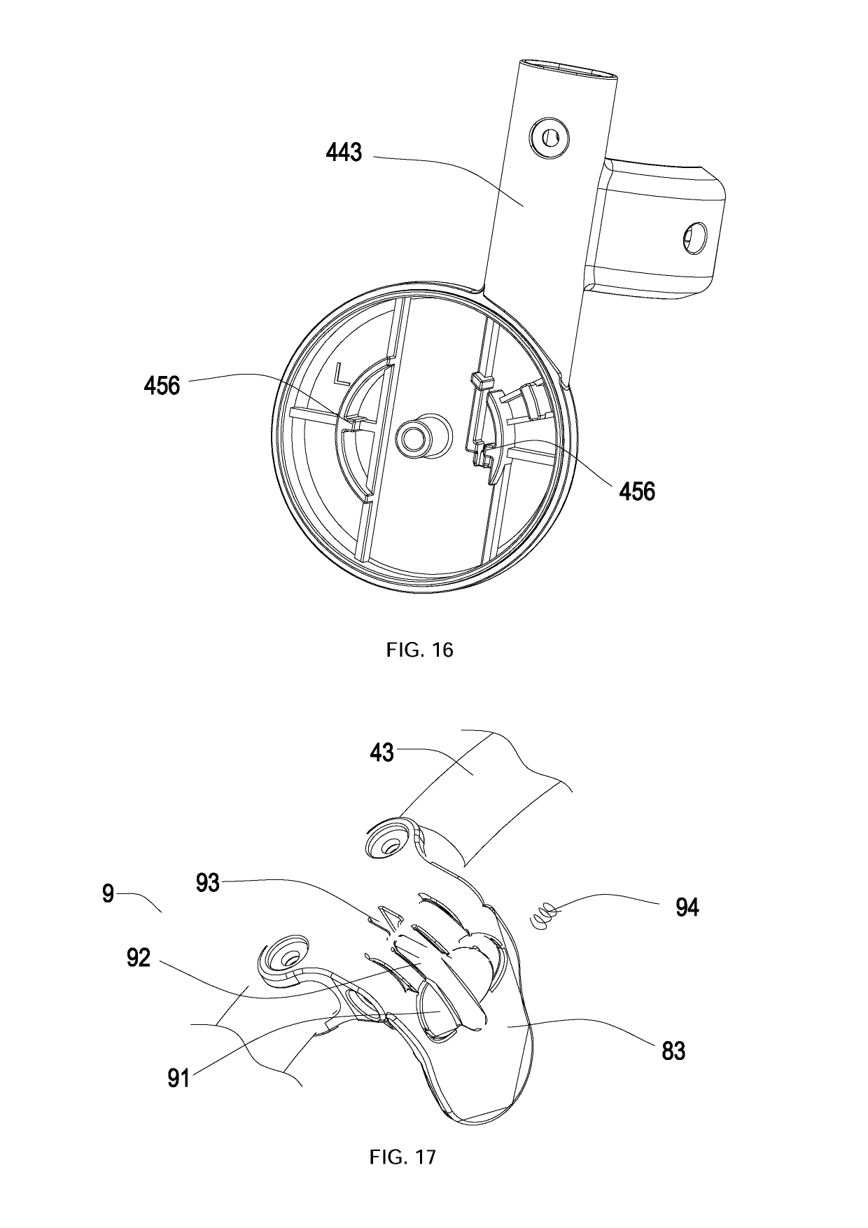

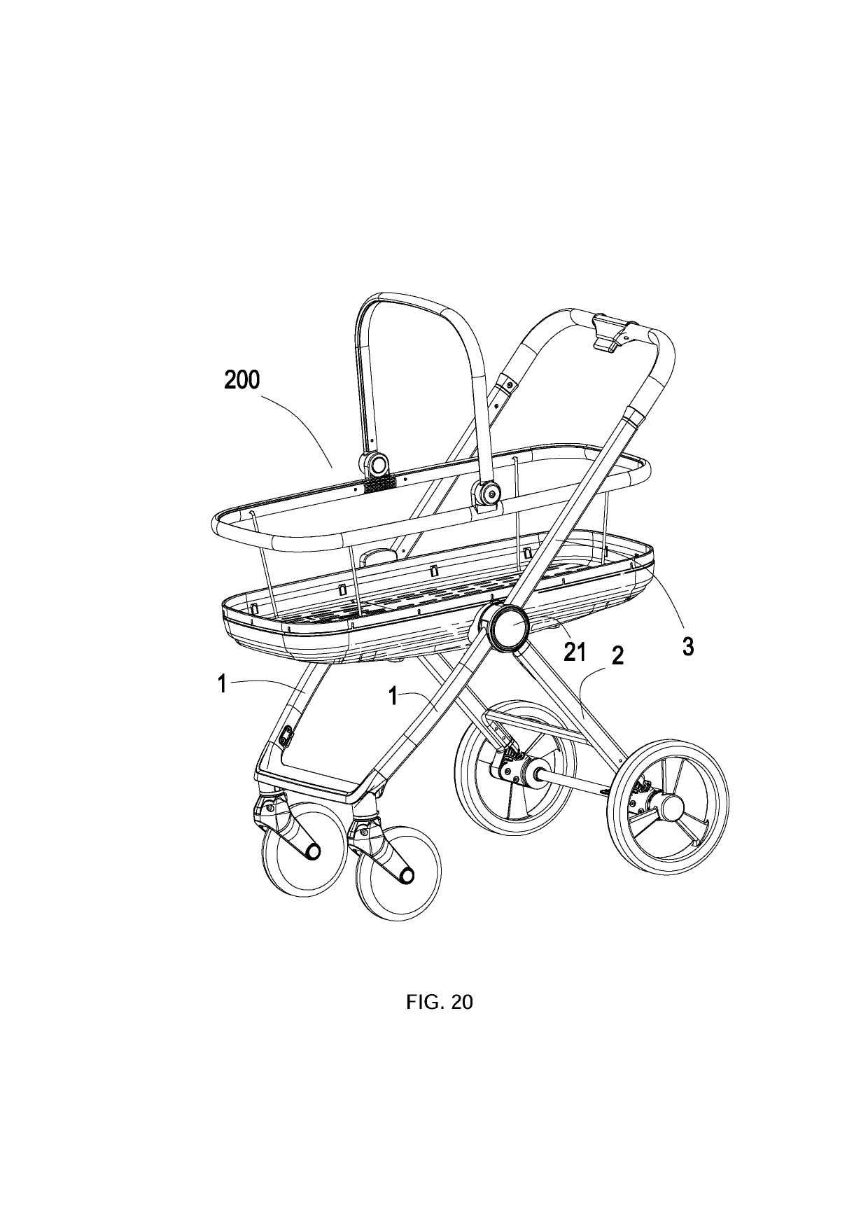

As shown in FIGS. 1 to 20, a child stroller frame comprises a push rod assembly 3, and a front support rod 1 and a rear support rod 2 both of which are connected with wheels 100, wherein two connecting seats 21 are respectively fixedly provided at two upper ends of the rear support rod 2, two first connecting portions 11 are respectively fixedly provided at two upper ends of the front support rod 1, two second connecting portions 32 are fixedly provided at two lower ends of the push rod assembly 3, a connector 22 that can be detachably connected to a seat assembly 4 is provided on an inner side of the connecting seat 21, each first connecting portion 11 is pivotally connected to the corresponding connecting seat 21 around a first axis A, the second connecting portion 32 is pivotally connected to the corresponding connecting seat 21 around a second axis B, a linkage rod 5 is pivotally connected to both of the first connecting portion 11 and the second connecting portion 32 to drive the front support rod 1 to rotate and fold toward the rear support rod 2 when the push rod assembly 3 is rotated and folded with respect to the rear support rod 2, a first end of the linkage rod 5 is connected to the first connecting portion 11 around the third axis C, and a second end of the linkage rod 5 is connected to the second connecting portion 232 around the fourth axis D. Each of the first connecting portion 11 and the second connecting portion 32 is provided with a locking position 61, and the connecting seat 21 is also provided with a locking member 62 that can slide with respect to the locking positions 61 and lock or disengage with the locking positions 61 at the same time, and the locking member 62 is provided with a first unlocking portion 63 exposed from the connecting seat 21 and can be pushed by a seat part 41 of the seat assembly 4 when the seat assembly 4 is rotated and folded toward the front support rod 1, so that the locking member 62 is disengaged from the locking positions 61, and a first reset spring 64 that can push the locking member 62 to reset is provided between the locking member 62 and the connecting seat 21.

As shown in FIGS. 3 to 7, when the stroller frame needs to be folded, the seat part 41 can push the first unlocking portion 63 when it is rotated and folded with respect to the rear support rod 2, so that the locking member 62 is disengaged from each locking position 61 at the same time. At this time, the front support rod 1, the rear support rod 2 and the push rod assembly 3 are unlocked from each other, and the user can operate the push rod assembly 3, at this time, the second connecting portion 32 rotates around the second axis B with respect to the connecting seat 21 to make the push rod assembly 3 move close to the rear support rod 2. During the rotation of the second connecting portion 32, the second connecting portion 32 drives one end of the linkage rod 5 to follow the movement, and the one end of the linkage rod 5 moves around the fourth axis D, and the other end of the linkage rod 5 is pulled to move around the third axis C and move with respect to the first connecting portion 11. At the same time, driven by the linkage rod 5, the first connecting portion 11 can rotate around the first axis A and move with respect to the connecting seat 21, so as to move close to the rear support rod 2, and the child stroller frame can be folded as a whole. The folding process is very simple, and the entire stroller frame can be unlocked by only pushing the seat part 41 to rotate and fold with respect to the rear support rod 2, and then the push rod assembly 3 is pushed to rotate and move close to the rear support rod 2 to complete the folding. Each of the first connecting portion 11 and the second connecting portion 32 are provided with the locking position 61, and the locking member 62 can be locked with the locking positions 61 on the first connecting portion 11 and the second connecting portion 32 at the same time, which can reduce shaking and make the entire frame safer when unfolded.

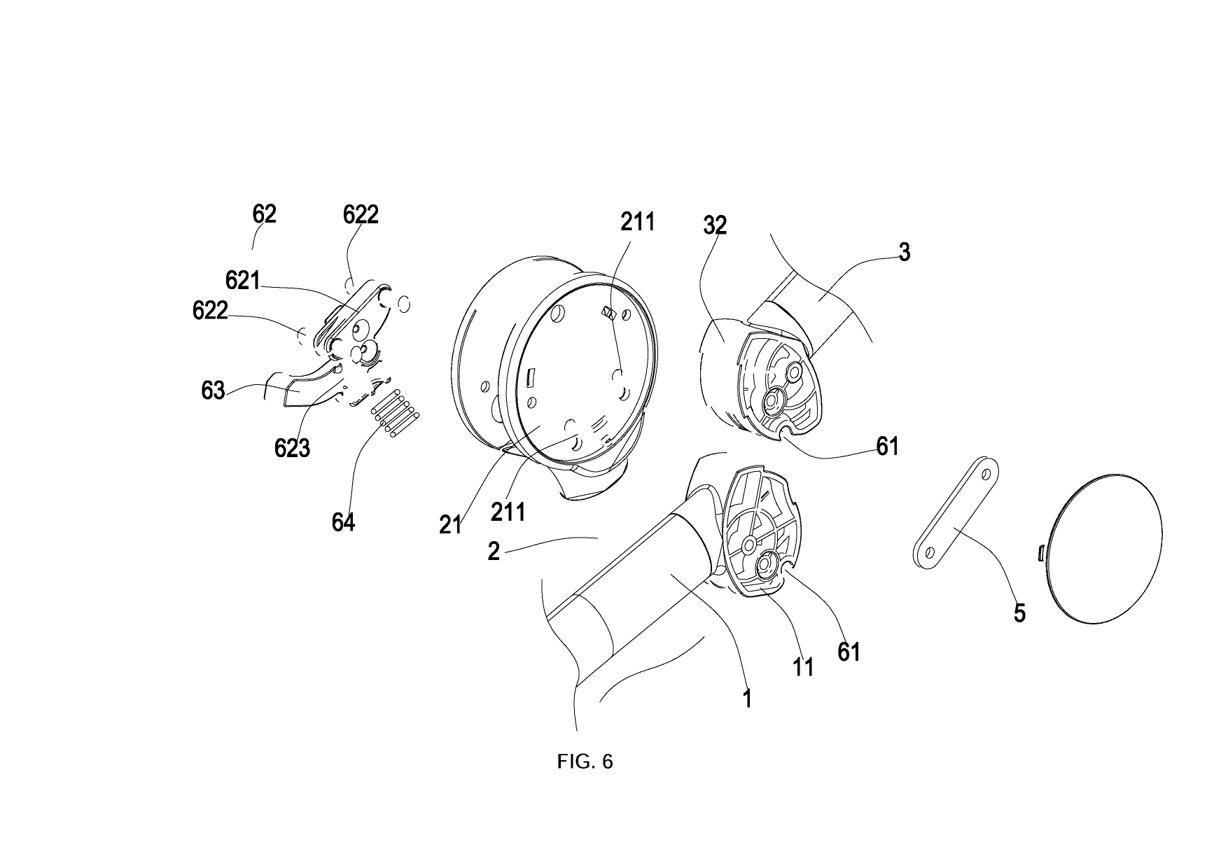

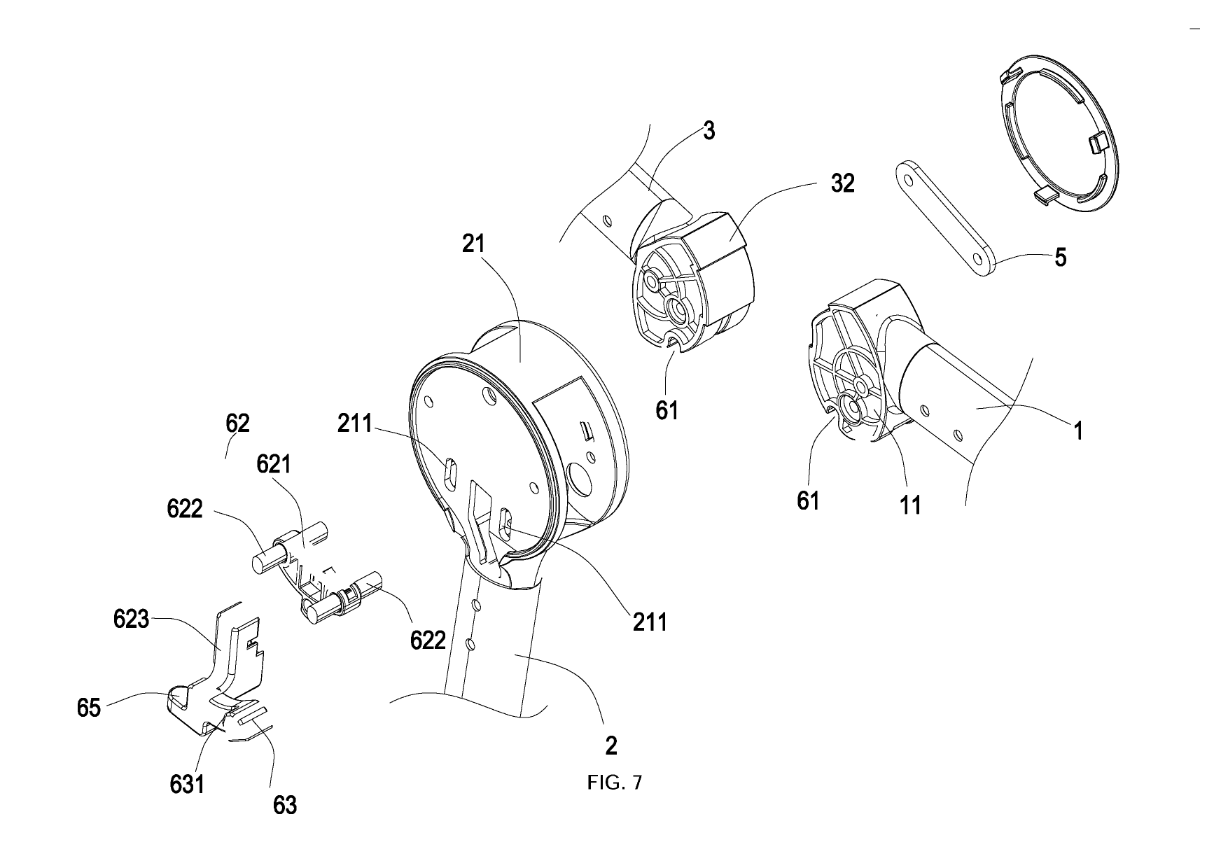

As shown in FIG. 6 and FIG. 7, the locking member 62 comprises a sliding seat 621 slidably coupled to the connecting seat 21, and the sliding seat 621 is provided with a locking pin 622 that can be locked into the locking position 61. The locking position 61 is a locking groove, and two locking pins 622 can be respectively locked into the locking grooves of the first connecting portion 11 and the second connecting portion 32 at the same time, so that the entire frame is safer when unfolded.

As shown in FIG. 6 and FIG. 7, the connecting seat 21 is provided with a sliding groove 211 capable of guiding the sliding movement of each locking pin 622. The sliding groove 211 is provided to guide the sliding movement of the locking pin 622 and control the sliding stroke of the locking member 62.

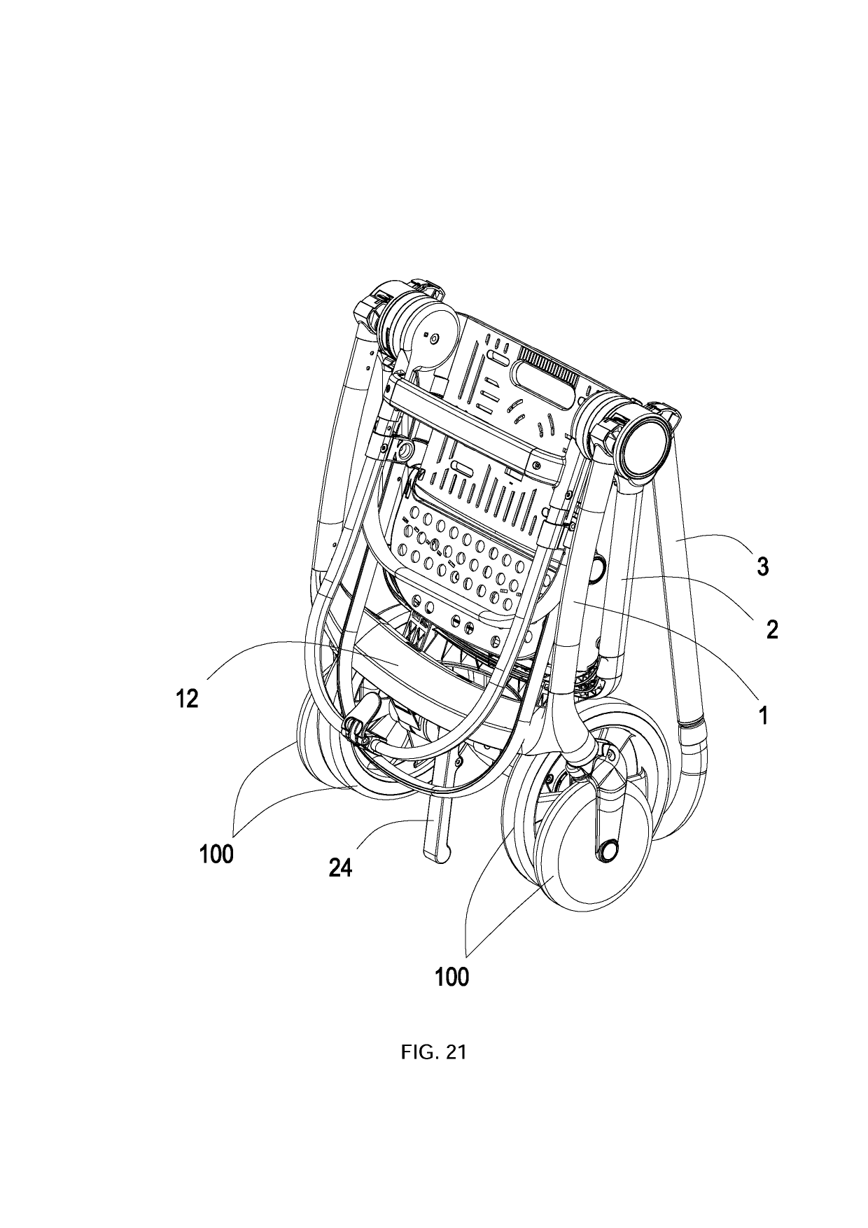

As shown in FIG. 1 and FIG. 21, the front support rod 1 is provided with a front cross bar 12 at a lower end thereof, the rear support rod 2 is provided with a rear cross bar 23 at a lower end thereof, the front cross bar 12 is provided with a rotating rod 24 which can rotate with respect to the front cross bar 23, a flexible belt 25 which can pull up the rotating rod 24 when the child stroller frame is in the unfolded state can be provided between the rotating rod 24 and the rear cross bar 23, and a torsion spring 26 which can push the rotating rod 24 to unfold when the child stroller frame is folded can be also provided between the rotating rod 24 and the front cross bar 12. In the unfolded state of the child stroller, the flexible belt 25 pulls up the rotating rod 24, the torsion spring 26 is in a deformed state, and the rotating rod 24 is separated from the ground, and in the folding process of the child stroller, the flexible belt 25 releases the rotating rod 24, the torsion spring 26 elastically resets and pushes the rotating rod 24 to rotate and unfold, at which time the rotating rod 24 can be supported on the ground, and the rotating rod 24 and the wheel 100 at the lower end of the rear support rod 2 are supported, so that the child stroller frame in the folded state can stand on the ground for convenient storage.

As shown in FIGS. 6 and 7, the locking member 62 further comprises a sliding block 623 connected to the sliding seat 621, and the sliding block 623 is partially extended outside the connecting seat 21. The first unlocking portion 63 is arranged on the sliding block 623, and the sliding block 623 is also provided with a second unlocking portion 65 exposed on the connecting seat 21 and capable of being operated to disengage the locking member 62 from the locking positions 61.

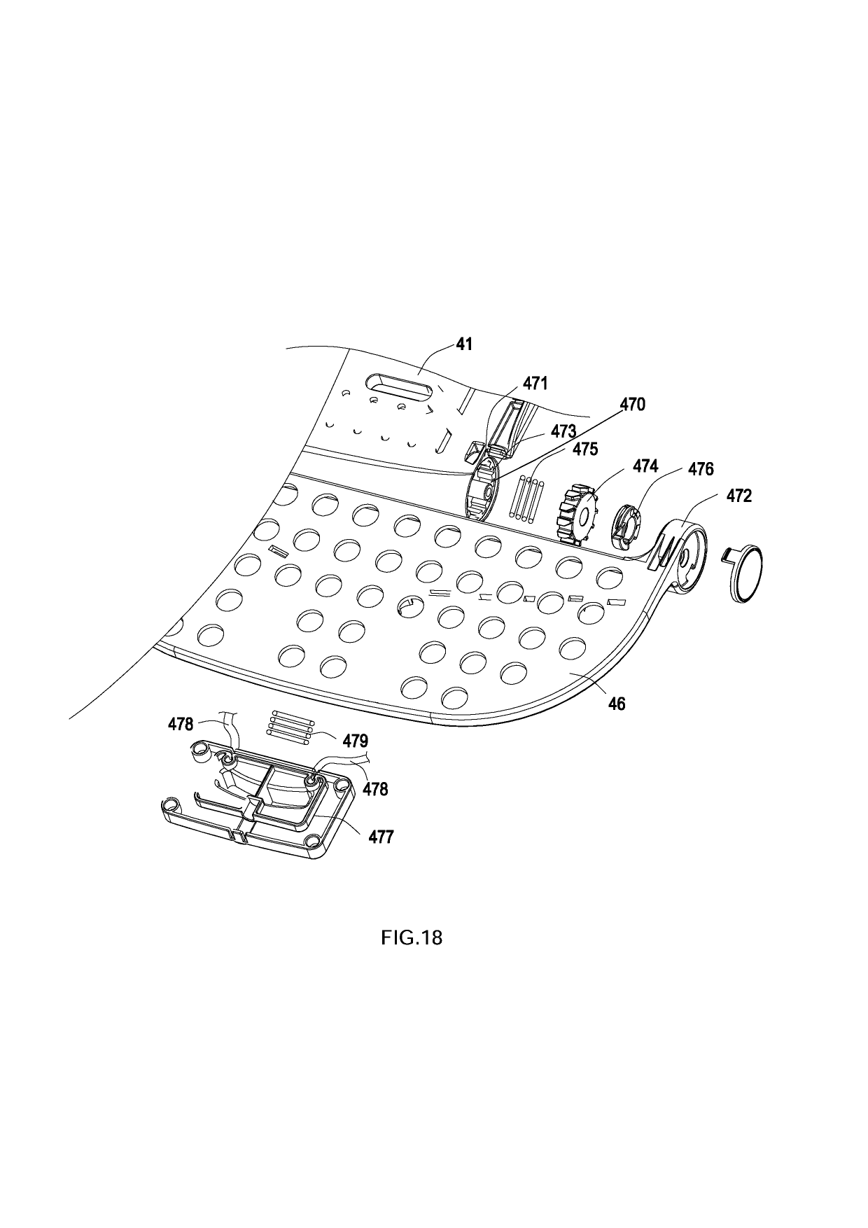

After the seat assembly 4 is removed from the connector 22, the user can also pull the sliding block 623 to slide by pulling the second unlocking portion 65, thereby disengaging the locking pins 622 on the sliding seat 621 from the locking positions 61. At this time, the front support rod 1, the rear support rod 2 and the push rod assembly 3 are also unlocked from each other without the drive of the seat part 41. Then, by rotating the push rod assembly 3, the front support rod 1 can be driven to rotate toward the rear support rod 2 through the linkage rod 5, and the child stroller frame without the seat assembly 4 can also be folded separately. Therefore, after a baby sleeping basket 200 is connected to the connector 22, as shown in FIG. 18, if the child stroller frame needs to be folded, the baby sleeping basket 200 can be removed first, and then the front support rod 1, the rear support rod 2 and the push rod assembly 3 can be unlocked by the second unlocking portion 65, so that the child stroller frame without the seat assembly 4 can be folded for easy storage and carrying. Therefore, when the seat assembly 4 is connected, the entirety can be folded, and when the baby sleeping basket 200 is connected, the front support rod 1, the rear support rod 2 and the push rod assembly 3 can also be folded. It has a wide range of applications, and the unlocking and folding operations are also very convenient and quick.

As shown in FIGS. 11 to 14, the seat assembly 4 comprises a mounting base 42 detachably connected to the connector 22, the seat part 41 is rotatably connected to the mounting base 42, the seat part 41 is provided with a backrest part 43 which can rotate with respect to the seat part 41 and an armrest part 44, and a locking assembly 45 that can lock the seat assembly 4 in the unfolded state is provided between the mounting base 42, the seat part 41, the backrest part 43 and the armrest part 44.

As shown in FIGS. 11 to 14, the seat part 41 comprises a seat plate 411 and an unlocking part 412 provided on the seat plate 411 and capable of pushing the first unlocking portion 63 to disengage the locking member 62 from the locking positions 61 when the seat part 41 rotates with respect to the mounting base 42. The unlocking part 412 comprises an unlocking slider 4121 slidably connected to the seat plate 411 and capable of pushing the first unlocking portion 63 to slide when the seat part 41 rotates and folds with respect to the mounting base 42, a resetting element 4122 capable of pushing the unlocking slider 4121 to reset is also provided between the unlocking slider 4121 and the seat plate 411, a first inclined surface 4123 is provided on the unlocking slider 4121, and a pushing surface 631 is provided on the first unlocking portion 63 to push the first inclined surface 4123 to retract the unlocking slider 4121 into the seat plate 411 when the seat assembly 4 is unfolded. When the seat assembly 4 is rotated and folded with respect to the mounting base 42, the unlocking slider 4121 rotates with the seat plate 411, and the unlocking slider 4121 gradually abuts against the first unlocking portion 63 and pushes the first unlocking portion 63 to slide downward, thereby causing the locking pins 622 to disengage from the locking positions 61; when the seat assembly 4 needs to be rotated and unfolded, the seat plate 411 is unfolded in the reverse direction. At this time, the first inclined surface 4123 on the unlocking slider 4121 gradually contacts the pushing surface 631 on the first unlocking portion 63, and retracts into the seat plate 411 under the pushing of the pushing surface 631, making way for the first unlocking portion 63, thereby preventing the first unlocking portion 63 from being stuck with the unlocking slider 4121.

As shown in FIGS. 11 to 13, a locking unit capable of locking the mounting base 42 and the connector 22 is provided between the mounting base 42 and the connector 22, and the locking unit comprises a lock position 71 provided on the connector 22, and a lock block 72 is provided on the mounting base 42, which can slide laterally with respect to the locking block 71 to engage in or disengage from the lock position 71, and an operation member 73 is also connected to the mounting base 42, which can slide vertically with respect to the lock block 72 to slide laterally, and a first elastic element 74 capable of pushing the lock block 72 to return to its original position is provided between the lock block 72 and the mounting base 42, and a second elastic element 75 capable of pushing the operation member 73 to return to its original position is provided between the operation member 73 and the mounting base 42. The mounting base 42 and the connector 22 are locked by the locking unit, which facilitates the quick installation of the mounting base 42 on the connector 22. At the same time, when the seat assembly 4 needs to be removed and separated, it is only necessary to press the operation member 73. When the operation member 73 is pressed, the operation member 73 slides vertically with respect to the mounting base 42, thereby pushing the lock block 72 to slide horizontally with respect to the mounting base 42. At this time, the lock block 72 gradually disengages from the lock position 71, and the seat assembly 4 can be removed from the connector 22.

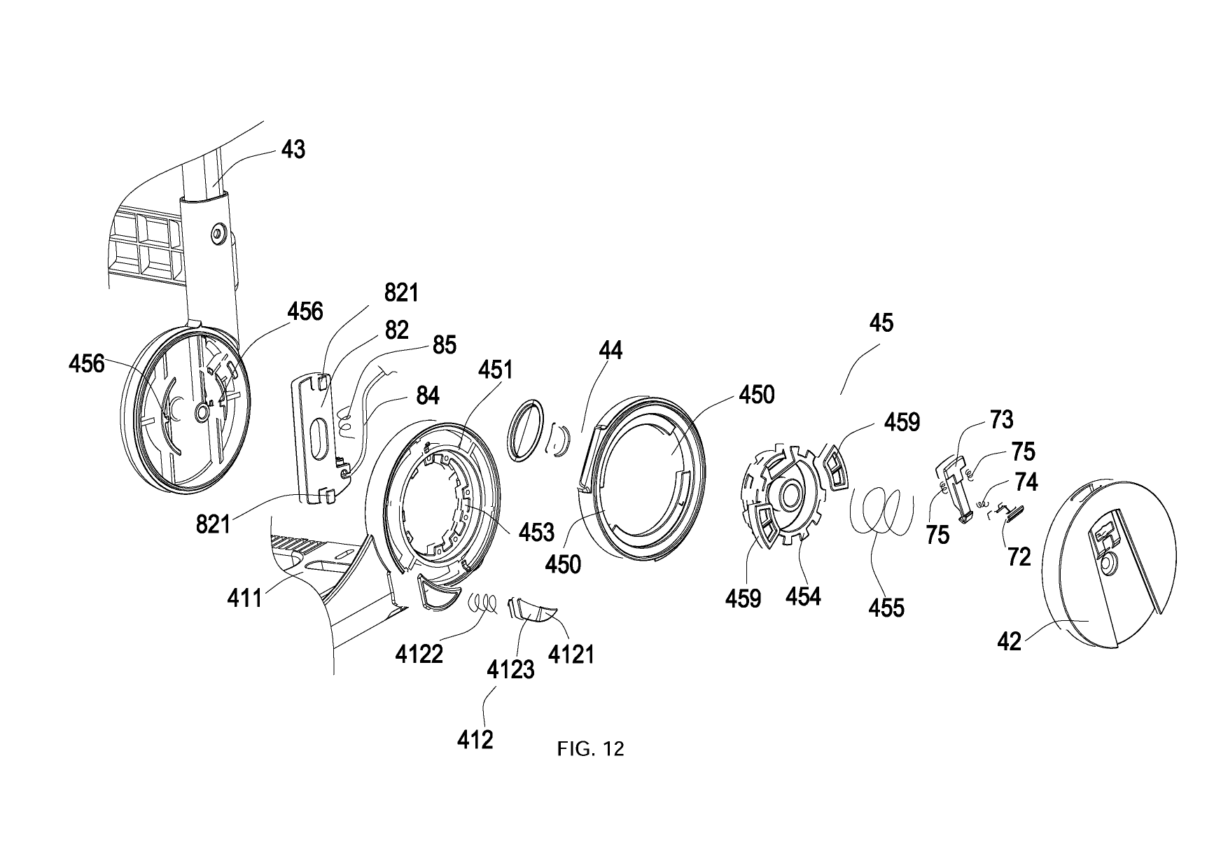

As shown in FIGS. 12 to 17, a gear adjustment structure capable of adjusting the tilt position of the backrest part 43 with respect to the seat part 41 is provided between the seat part 41 and the backrest part 43, and the gear adjustment structure comprises a plurality of adjustment positions 81 provided on the seat part 41, a sliding member 82 capable of sliding relative thereto is provided on the backrest part 43, a clamping portion 821 capable of being snapped into the adjustment position 81 is provided on the sliding member 82, an unlocking member 83 capable of rotating relative thereto is provided on the backrest part 43, a cable 84 capable of connecting the unlocking member 83 and the sliding member 82 is provided between the unlocking member 83 and the sliding member 82, a second reset spring 85 capable of pushing the sliding member 82 to return to its original position is provided between the sliding member 82 and the backrest part 43, a stopper 413 capable of preventing the sliding member 82 from rotating forward is also provided on the backrest part 43. A second locking assembly 9 is provided between the unlocking member 83 and the backrest part 43. The second locking assembly 9 comprises an unlocking button 91 provided on the unlocking member 83. The unlocking button 91 is provided with a protrusion 92. The backrest part 43 is provided with a groove 93 capable of making way for the protrusion 92 so that the cable 84 pulls the sliding member 82 away from the stopper 413. An elastic part 94 capable of pushing the protrusion 92 on the unlocking button 91 and the backrest part 43 to displace the groove 93 is provided between the unlocking button 91 and the backrest part 43. In order to prevent an adult from accidentally rotating and folding the backrest part 43 toward the seat part 41 when adjusting the tilting level between the backrest part 43 and the seat 41, the second locking assembly 9 is provided to prevent the adult from operating incorrectly. When the adult does not unlock the second locking assembly 9, the unlocking member 83 can still rotate with respect to the backrest part 43 to unlock the gear adjustment structure, but at this time the position of the sliding member 82 is supported by the stopper 413, and the clamping portion 821 will be pressed against the stopper 413 when rotating to prevent the backrest part 43 from rotating forward with respect to the seat part 41. When the seat assembly 4 needs to be folded, the unlocking button 91 is pushed horizontally to align the protrusion 92 on the unlocking button 91 with the groove 93. At this time, the unlocking member 83 has enough rotation distance to pull the cable 84, and the clamping portion 821 on the sliding member 82 is separated from the stopper 413, and the backrest part 43 can be rotated to fold toward the seat 41. Furthermore, when the backrest part 43 is rotated and folded, the backrest part 43 drives the locking assembly 45 to unlock, and the seat part 41 can be rotated with respect to the mounting base 42. At this time, the seat part 41 pushes the first unlocking portion 63 to achieve linked unlocking, ensuring that the front support rod 1, the rear support rod 2 and the push rod assembly 3 are unlocked, facilitating the folding operation.

As shown in FIGS. 12 to 16, the locking assembly 45 comprises a left connecting shell 451 disposed on the seat part 41 and a right connecting shell 452 disposed on the mounting base 42. Each of the left connecting shell 451 and the right connecting shell 452 is provided with a spline groove 453. The left connecting shell 451 and the right connecting shell 452 enclose a sealed space. The sealed space is provided with a first spline 454 which can move laterally therein and can be simultaneously engaged with the spline grooves 453 on the left connecting shell 451 and the right connecting shell 452. A third reset spring 455 is also provided between the first spline 454 and the right connecting shell 452, and a pushing protrusion 456 is provided on the backrest part 43, which can push the first spline 454 to slide laterally and disengage from the spline groove 453 on the left connecting shell 451 when the backrest part 43 is rotated and folded, and a clearance space 457 that can accommodate the pushing protrusion 456 is provided on the first spline 454, and a first pushing surface 458 that can be pushed by the pushing protrusion 456 is also provided in the clearance space 457 on the first spline 454. When it is necessary to unlock the locking assembly 45, first unlock the second locking assembly 9, then unlock the gear adjustment structure, rotate the backrest part 43 forward, and the backrest part 43 will be rotated and folded toward the seat part 41. At this time, the pushing protrusion 456 on the backrest part 43 will gradually push the first pushing surface 458 on the spline 444 along with the rotation, thereby pushing the first spline 454 to slide laterally. At this time, the first spline 454 will gradually detach from the spline groove 453 on the left connecting shell 451 and enter into the right connecting shell 452. At this time, the seat part 41 can be rotated and folded with respect to the mounting base 42.

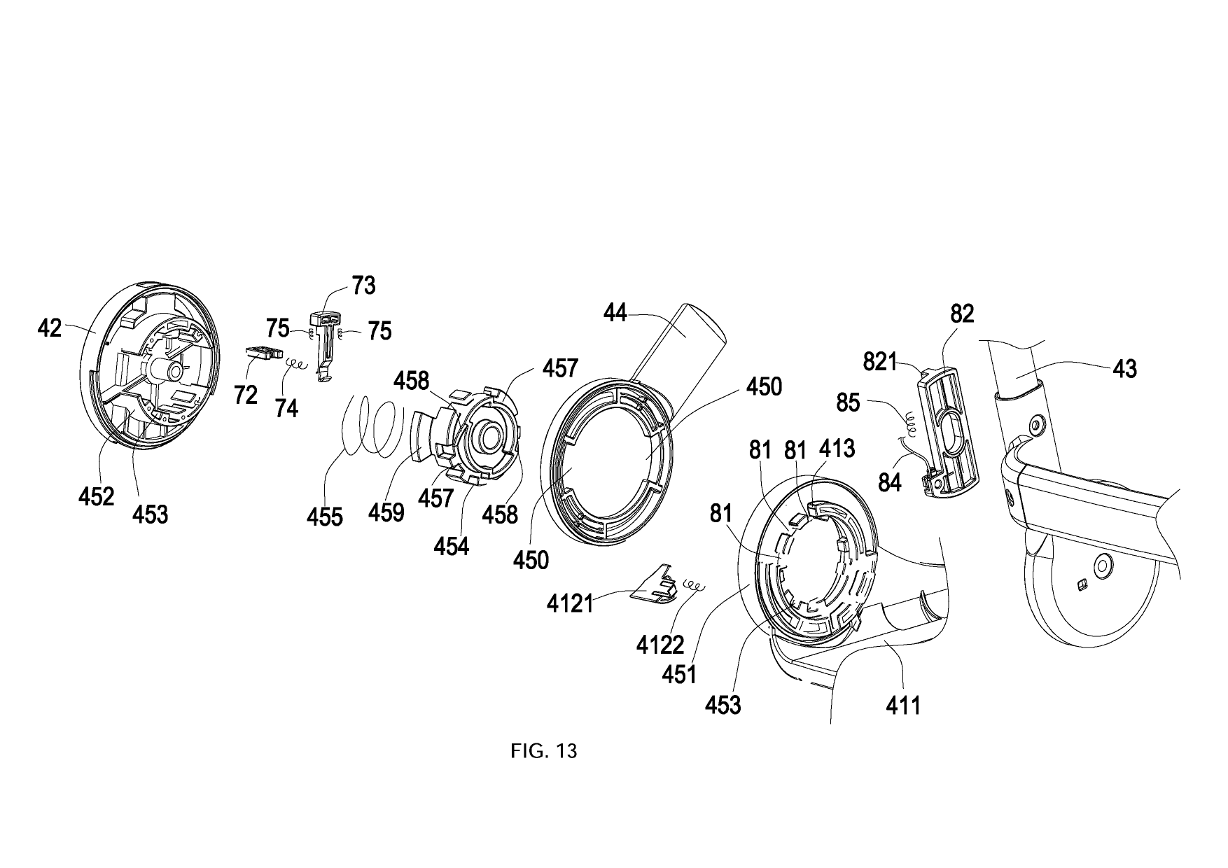

As shown in FIG. 12 and FIG. 13, the first spline 454 is further provided with a protruding block 459, and the armrest part 44 is provided with a snap-in groove 450 capable of being snapped by the block 459 to prevent the armrest part 44 from rotating and folding. When the first spline 454 slides, the protruding block 459 on the first spline 454 also disengages from the snap-in groove 450 on the armrest part 44, and the armrest part 44 can be rotated with respect to the seat part 41 and folded.

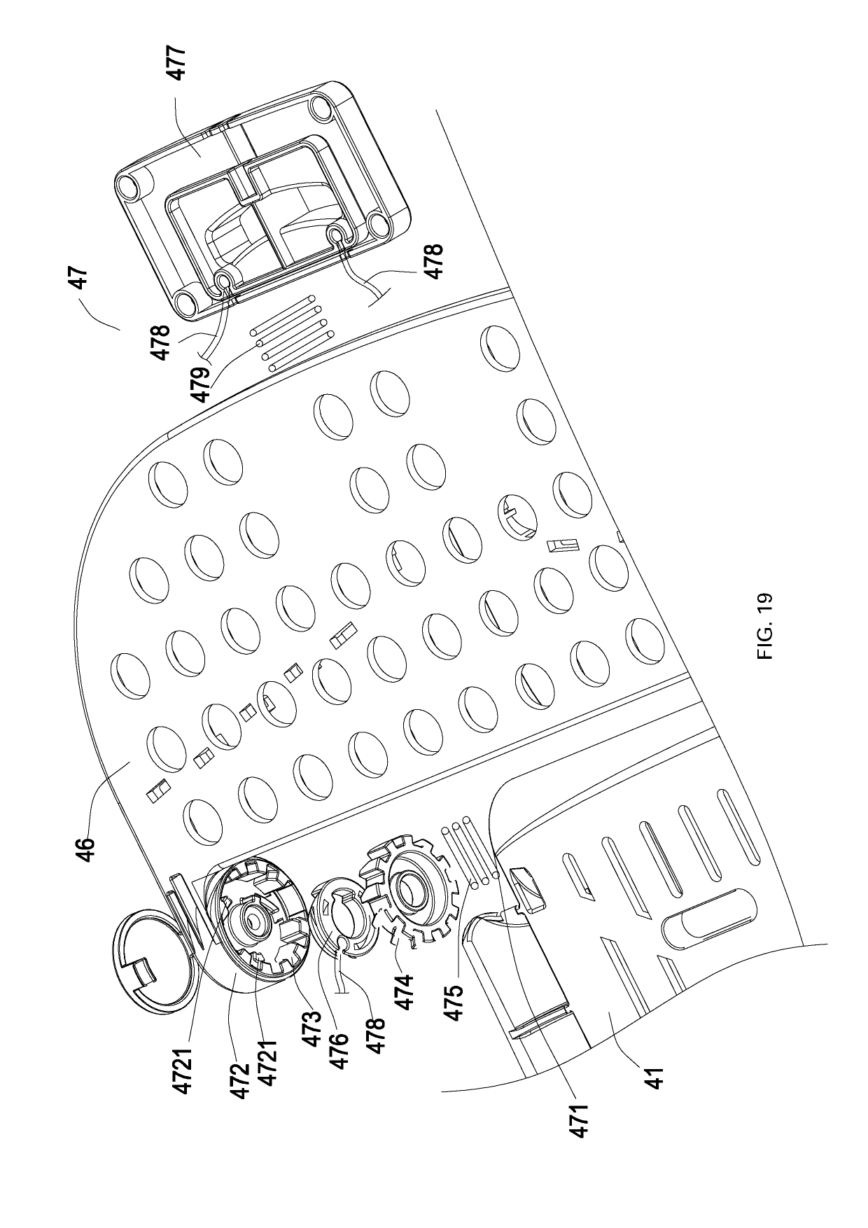

As shown in FIGS. 18 and 19, the seat assembly 4 further comprises a leg rest plate 46 rotatably connected to the seat part 41, and an adjustment assembly 47 capable of adjusting the angle of the leg rest plate 46 with respect to the seat part is provided between the leg rest plate 46 and the seat part 41. The adjustment assembly 47 comprises a left rotating shell 471 provided on the seat part 41 and a right rotating shell 472 provided on the leg rest plate 46. A slot 473 is provided in each of the left rotating shell 471 and the right rotating shell 472. Each of the left rotating shell 471 and the right rotating shell 472 forms a movement space 470. A second spline 474 capable of moving laterally therein and simultaneously engaging with the slots 473 of the left rotating shell 471 and the right rotating shell 472 is provided in the movement space 470. There is also an elastic component 475 provided between the second spline 474 and the left rotating shell 471, and a rotating member 476 capable of rotating with respect to the second spline 474 and the right rotating shell 472 is provided between the second spline 474 and the right rotating shell 472. A pusher protrusion 4721 capable of pushing the rotating member 476 to slide horizontally when the rotating member 476 rotates is provided on the right rotating shell 472, and when the rotating member 476 slides horizontally, the second spline 474 can be disengaged from the slot 473 on the right rotating shell 472. An operating element 477 capable of sliding with respect to the leg rest plate 46 is also provided on the leg rest plate 46. A second pull cable 478 capable of driving the rotating member 476 to move when the operating element 477 is operated is provided between the operating element 477 and the rotating member 476, and an elastic reset member 479 capable of pushing the operating element to reset is provided between the operating element 477 and the leg rest plate 46. When the position of the leg rest plate 46 with respect to the seat part 41 needs to be adjusted, the operating element 477 is operated, the operating element 477 slides with respect to the seat part 41, the second cable 478 is pulled, and when the second cable 478 is pulled, the rotating member 476 is driven to rotate, and the rotating member 476 rotates with respect to the second spline 474 and the right rotating shell 472. When the rotating member 476 is rotated, the rotating member 476 is pushed by the pusher protrusion 4721 and moves horizontally with respect to the right rotating shell 472. At this time, the second spline 474 is pushed to slide horizontally in the movement space 470 and gradually disengages from the slot 473 on the right rotating shell 472 and enters the left rotating shell 471. The adjustment component 47 is unlocked, and the leg rest plate 46 can rotate with respect to the seat part 41 to adjust the position. When the position adjustment is completed, the operating element 477 is released, and the elastic reset member 479 pushes the second spline 474 and the rotating element 476 to reset. The second spline 474 is again engaged with the slots 473 on the left rotating shell 471 and the right rotating shell 472. In one embodiment, the leg rest plate 46 and the seat part 41 are both connected at both sides with the adjustment components 47. The two adjustment components 47 can be unlocked by operating one operating element 477, which is more convenient. Compared with the push-type adjustment component, the user can complete the operation with one hand, which is more convenient.

The embodiment is described in detail above in conjunction with the accompanying drawings, but the present invention is not limited to the above embodiment, and various changes can be made within the knowledge scope of ordinary technicians in the technical field without departing from the present purpose.

What is claimed is:

1. A child stroller frame comprising:
a push rod assembly comprising a lower end;
a front support rod comprising an upper end and a lower end;
a rear support rod comprising an upper end and a lower end;
wheels connected to the front rod and the rear support rod respectively;
a connecting seat fixed at the upper end of the rear support rod;
a first connecting portion fixed at the upper end of the front support rod;
a second connecting portion fixed at the lower end of the push rod assembly;
a seat assembly comprising a seat part;
a connector, which is capable of being detachably connected to the seat assembly, is provided on an inner side of the connecting seat; and
a linkage rod provided between the first connecting portion and the second connecting portion, wherein the linkage rod is pivotally connected to the first connecting portion and the second connecting portion and is capable of driving the front support rod to rotate toward the rear support rod when the push rod assembly is rotated and folded with respect to the rear support rod, wherein the first connecting portion and the connecting seat are pivotally connected around a first axis, the second connecting portion and the connecting seat are pivotally connected around a second axis, wherein a first end of the linkage rod is connected to the first connecting portion around a third axis, and a second end of the linkage rod is connected to the second connecting portion around a fourth axis, wherein the first connecting portion and the second connecting portion are both provided with locking positions, and the connecting seat is provided with a locking member that is arranged to slide with respect to the connecting seat and lock or disengage with each locking position at the same time, wherein the locking member is provided with a first unlocking part exposed on the connecting seat and is capable of being pushed by the seat part of the seat assembly when the seat assembly is rotated and folded forward toward the front support rod, so that the locking member is disengaged from the locking positions, wherein a first reset spring, which is arranged to push the locking member to reset, is provided between the locking member and the connecting seat.

2. The child stroller frame according to claim 1, wherein the locking member comprises a sliding seat slidably connected to the connecting seat, and the sliding seat is provided with two locking pins which are capable of being respectively locked into the locking positions, wherein the connecting seat is provided with a sliding groove capable of guiding each locking pin to slide.

3. The child stroller frame according to claim 1, wherein a front cross bar is provided at a lower end of the front support rod, a rear cross bar is provided at the lower end of the rear support rod, a rotating rod which is capable of rotating with respect to the front cross bar is provided on the front cross bar, a flexible belt, which is arranged to pull up the rotating rod when the child stroller frame is in an unfolded state, is provided between the rotating rod and the rear cross bar, and a torsion spring, which is arranged to push the rotating rod to unfold when the stroller frame is folded, is provided between the rotating rod and the front cross bar.

4. The child stroller frame according to claim 2, wherein the locking member further comprises a sliding block connected to the sliding seat, the sliding block is partially extended outside the connecting seat, the first unlocking portion is arranged on the sliding block, and the sliding block is provided with a second unlocking portion exposed on the connecting seat and capable of being operated to disengage the locking member from the locking positions.

5. The child stroller frame according to claim 1, wherein the seat assembly comprises a mounting base detachably connected to the connector, the seat part is rotatably connected to the mounting base, the seat part is provided with a backrest part and an armrest part, the backrest part is capable of rotating with respect to the seat part, wherein a locking assembly is provided to lock the seat assembly in an unfolded state.

6. The child stroller frame according to claim 5, wherein the seat part comprises a seat plate and an unlocking part which is arranged on the seat plate to push the first unlocking portion to disengage the locking member from the locking positions when the seat part is rotated with respect to the mounting base, wherein the unlocking part comprises an unlocking slider which is slidably connected to the seat plate to push the first unlocking portion to slide when the seat part is rotated and folded with respect to the mounting base, wherein a resetting element, which is arranged to push the unlocking slider to reset, is arranged between the unlocking slider and the seat plate, wherein a first inclined surface is arranged on the unlocking slider, the first unlocking portion is provided with a pushing surface which is arranged to push the first inclined surface to retract the unlocking slider into the seat plate when the seat assembly is unfolded.

7. The child stroller frame according to claim 5, wherein a locking unit, which is capable of locking the mounting base and the connector, is provided between the mounting base and the connector, the locking unit comprises a lock position provided on the connector, the mounting base is provided with a lock block capable of sliding laterally with respect to the lock block to engage in or disengage from the lock position, an operating member is connected to the mounting base and is capable of sliding vertically with respect to the mounting base to push the lock block to slide laterally, a first elastic element, which is capable of pushing the lock block to reset, is provided between the lock block and the mounting base, and a second elastic element, which is capable of pushing the operating member to reset, is provided between the operating member and the mounting base.

8. The child stroller frame according to claim 5, wherein a position adjustment structure, which is capable of adjusting an inclination position of the backrest part with respect to the seat part, is provided between the seat part and the backrest part, the position adjustment structure comprises a plurality of adjustment positions provided on the seat part, a sliding member capable of sliding with respect to the backrest part is provided on the backrest part, a snap-in portion capable of being snapped into the adjustment position is provided on the sliding member, an unlocking member capable of rotating relative thereto is provided on the backrest part, a first cable capable of connecting the unlocking member and the sliding member is provided between the unlocking member and the sliding member, and a second reset spring capable of pushing the sliding member to reset is provided between the sliding member and the backrest part.

9. The child stroller frame according to claim 8, wherein the seat part is further provided with a stopper which is arranged to prevent the sliding member from rotating forward, and a second locking assembly is provided between the unlocking member and the backrest part, wherein the second locking assembly comprises an unlocking button provided on the unlocking member, a protrusion is provided on the unlocking button, and a groove is provided on the backrest part to make way for the protrusion so that the first cable pulls the sliding member out of the stopper, wherein an elastic part, which is capable of pushing the protrusion on the unlocking button and the backrest part to be misaligned, is provided between the unlocking button and the backrest part.

10. The child stroller frame according to claim 5, wherein the seat assembly further comprises a leg rest plate rotatably connected to the seat part, wherein an adjustment assembly, which is capable of adjusting an angle of the leg rest plate with respect to the seat part, is provided between the leg rest plate and the seat part, the adjustment assembly comprises a left rotating shell provided on the seat part and a right rotating shell provided on the leg rest plate, a slot is provided in each of the left rotating shell and the right rotating shell, the left rotating shell and the right rotating shell form an movement space, a second spline is provided in the movement space to move laterally therein, so as to be engaged with the slots of the left rotating shell and the right rotating shell at the same time, and an elastic component is provided between the second spline and the left rotating shell, a rotating member, which is capable of rotating with respect to the second spline and the right rotating shell, is provided between the second spline and the right rotating shell, and a pusher protrusion is arranged to push the rotating member to slide horizontally when the rotating member is rotated, and when the rotating member slides horizontally, the second spline is disengaged from the slot on the right rotating shell, and the leg rest plate is further provided with an operating element which is capable of sliding with respect to the leg rest plate, a second cable, which is capable of driving the rotating member to move when the operating element is operated, is provided between the operating element and the rotating member, and an elastic reset member, which is capable of pushing the operating element to reset, is provided between the operating element and the leg rest plate.
